(19) United States
(12) Patent Application Publication
(10) Pub. No.: US 2025/0384572 A1
(43) Pub. Date: Dec. 18, 2025

(54) METHOD, APPARATUS, DEVICE AND STORAGE MEDIUM FOR INFORMATION PROCESSING

(71) Applicants: Beijing Zitiao Network Technology Co., Ltd., Beijing (CN); Lemon Inc., Grand Cayman (KY)

(72) Inventors: Lihe Yang, Beijing (CN); Bingyi Kang, Los Angeles, CA (US); Zilong Huang, Singapore (SG); Jiashi Feng, Singapore (SG)

(21) Appl. No.: 19/235,352

(22) Filed: Jun. 11, 2025

(30) Foreign Application Priority Data
Jun. 12, 2024 (CN) 202410757296.5

(51) Int. Cl. G06T 7/50

(52) U.S. Cl. CPC G06T 7/50; G06T 2207/20081

(57) ABSTRACT

Embodiments of the disclosure provide a method, an apparatus, a device and a computer-readable storage medium for information processing. The method proposed herein includes: training a first depth prediction model by using a first sample set, the first sample set including a set of synthesized images and annotated depth information corresponding to the set of synthesized images; generating predicted depth information for a set of real images based on the trained first depth prediction model; constructing a second sample set based on the set of real images and the predicted depth information; and training a second depth prediction model by using the second sample set, a scale of the second depth prediction model being smaller than that of the first depth prediction model.

### CROSS-REFERENCE

This application claims the benefit of Chinese Patent Application No. 202410757296.5 filed on Jun. 12, 2024, entitled “METHOD, APPARATUS, DEVICE AND STORAGE MEDIUM FOR INFORMATION PROCESSING”, which is hereby incorporated by reference in its entirety.

### FIELD

Example embodiments of the present disclosure generally relate to the field of computers, and more particularly, to a method, an apparatus, a device and a computer-readable storage medium for information processing.

### BACKGROUND

A monocular depth estimation technology, which aims to recover 3D scene depth information from a single image, has important applications in fields such as robot vision. A traditional depth estimation technology still has the problems of insufficient accuracy and limited generalization ability when dealing with complex scenes and transparent or reflective objects. In addition, the noise and loss of details in real-world data further limit the accuracy and reliability of depth estimation.

### SUMMARY

In a first aspect of the present disclosure, a method for information processing is provided. The method proposed herein includes: training a first depth prediction model by using a first sample set, the first sample set including a set of synthesized images and annotated depth information corresponding to the set of synthesized images; generating predicted depth information for a set of real images based on the trained first depth prediction model; constructing a second sample set based on the set of real images and the predicted depth information; and training a second depth prediction model by using the second sample set, a scale of the second depth prediction model being smaller than that of the first depth prediction model.

In a second aspect of the present disclosure, an apparatus for information processing is provided. The apparatus includes: a first training module, configured to train a first depth prediction model by using a first sample set, the first sample set including a set of synthesized images and annotated depth information corresponding to the set of synthesized images; an information generation module, configured to generate predicted depth information for a set of real images based on the trained first depth prediction model; a sample construction module, configured to construct a second sample set based on the set of real images and the predicted depth information; and a second training module, configured to train a second depth prediction model by using the second sample set, a scale of the second depth prediction model being smaller than that of the first depth prediction model.

In a third aspect of the present disclosure, an electronic device is provided. The device includes at least one processing unit; and at least one memory, which is coupled to the at least one processing unit and configured to store instructions executed by the least one processing unit. The instructions, when being executed by the least one processing unit, cause the device to perform the method in the first aspect.

In a fourth aspect of the present disclosure, a computer-readable storage medium is provided. The computer-readable storage medium is configured to store a computer program thereon, the computer program, being executable by a processor, implementing the method in the first aspect.

It should be understood that the content described in this Summary section is not intended to limit the key features or important features of the embodiments in the present disclosure, nor is it intended to limit the scope of the present disclosure. The other features of the present disclosure are readily understood through the following description.

### BRIEF DESCRIPTION OF THE DRAWINGS

The above and other features, advantages and aspects of various embodiments of the present disclosure will become more apparent in conjunction with the accompanying drawings and with reference to the following detailed description. In the accompanying drawings, the same or similar reference numerals represent the same or similar elements, in which:

FIG. 1 shows a schematic diagram of an information processing system according to some embodiments of the present disclosure;

FIG. 2 shows a flowchart of an information processing process according to some embodiments of the present disclosure;

FIG. 3 shows a schematic structural block diagram of an apparatus for information processing according to some embodiments of the present disclosure; and

FIG. 4 is a block diagram of an electronic device that can implement a plurality of embodiments of the present disclosure.

### DETAILED DESCRIPTION

The embodiments of the present disclosure are described in detail below with reference to the accompanying drawings. Although certain embodiments of the present disclosure are shown in the drawings, it should be understood that the present disclosure may be implemented in various forms and should not be construed as being limited to the embodiments described herein. Rather, these embodiments are provided for more thorough and complete understanding of the present disclosure. It should be understood that the accompanying drawings and embodiments of the present disclosure are only used for an illustrative purpose, but are not intended to limit the protection scope of the present disclosure.

It should be noted that the title of any section/subsection provided in this specification is not restrictive. Various embodiments are described throughout this specification, and any type of embodiment can be included under any section/subsection. In addition, the embodiment described in any section/subsection may be combined in any way with any other embodiment described in the same section/subsection and/or in a different section/subsection.

In the description of embodiments of the present disclosure, the term “including” and its similar terms shall be understood as open-ended inclusion, i.e., “including but not limited to”. The term “based on” should be understood as “at least partially based on”. The terms “one embodiment” or “this embodiment” should be understood as “at least one embodiment”. The term “some embodiments” should be understood as “at least some embodiments”. Other explicit and implicit definitions may also be included below. The terms “first”, “second”, etc., may refer to different or same objects. Other explicit and implicit definitions may also be included below.

The embodiments of the present disclosure may involve user data, the acquisition and/or use of data, etc. These aspects are in accordance with the corresponding laws and regulations and relevant regulations. In the embodiment of the present disclosure, the collection, acquisition, handling, processing, forwarding, use, etc. of all data are carried out on the premise that the user knows and confirms. Accordingly, when implementing various embodiments of the present disclosure, the user shall be appropriately informed of the type, scope of use, and usage scenarios of the data or information that may be involved in accordance with relevant laws and regulations and the user's authorization is acquired. The specific informing and/or authorization method may vary according to the actual situations and application scenarios, and the scope of the present disclosure is not limited in this regard.

If the schemes described in this specification and embodiments involve the processing of personal information, they will be processed on a lawful basis (such as obtaining the consent from a personal information subject, or necessary for the performance of a contract, etc.), and the processing will only be carried out within the scope of provisions or agreements. If the user refuses to process personal information other than the necessary information required for the basic functions, the use of the basic functions by user will not be affected.

As mentioned above briefly, a traditional depth estimation technology still has the problems of insufficient accuracy and limited generalization ability when dealing with complex scenes and transparent or reflective objects. In addition, traditional depth estimation models perform poorly when generalizing to unseen scenes, and it is difficult for traditional solutions to achieve efficient inference speed while maintaining the prediction accuracy.

Embodiments of the present disclosure provide a scheme for information processing. According to this scheme, a first depth prediction model is trained by using a first sample set, the first sample set including a set of synthesized images and annotated depth information corresponding to the set of synthesized images. Further, predicted depth information for a set of real images may be generated based on the trained first depth prediction model. Furthermore, a second sample set may be constructed based on the set of real images and the predicted depth information. Correspondingly, a second depth prediction model may be trained by using the second sample set, a scale of the second depth prediction model being smaller than that of the first depth prediction model.

In this way, the implementation of the present disclosure can train a large-scale model (also known as a teacher model) based on synthesized images, generate fine pseudo-depth labels of the real images, and then train a small-scale model (also known as a student model) by using these labels, thereby realizing high-precision and fast inference of depth prediction while ensuring the generalization ability of the model.

Various example implementations of this scheme are described in detail below in conjunction with the accompanying drawings.

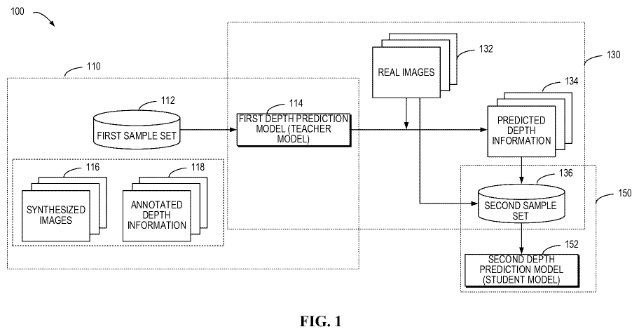

FIG. 1 illustrates a schematic diagram of an example information processing system 100 in which embodiments of the present disclosure can be implemented. As shown in FIG. 1, a processing flow of the information processing system 100 may include three stages, namely, a first stage 110, a second stage 130 and a third stage 150.

In the first stage 110, the information processing system 100 may train a first depth prediction model 114 (which may also be referred to as the teacher model) by using a first sample set 112. The first sample set 112 may include a plurality of synthesized images 116 and corresponding annotated depth information 118.

In the second stage 130, the information processing system 100 may process a plurality of real images 132 by using the trained first depth prediction model to generate corresponding prediction depth information 134. In addition, the information processing system 100 may construct a second sample set 136 based on the plurality of real images 132 and the corresponding predicted depth information 134.

In the third stage 150, the information processing system 100 may train a second depth prediction model 152 (which may also be referred to as the student model) by using the second sample set 136. Compared with the teacher model, the student model has a smaller scale, e.g., a fewer model parameters.

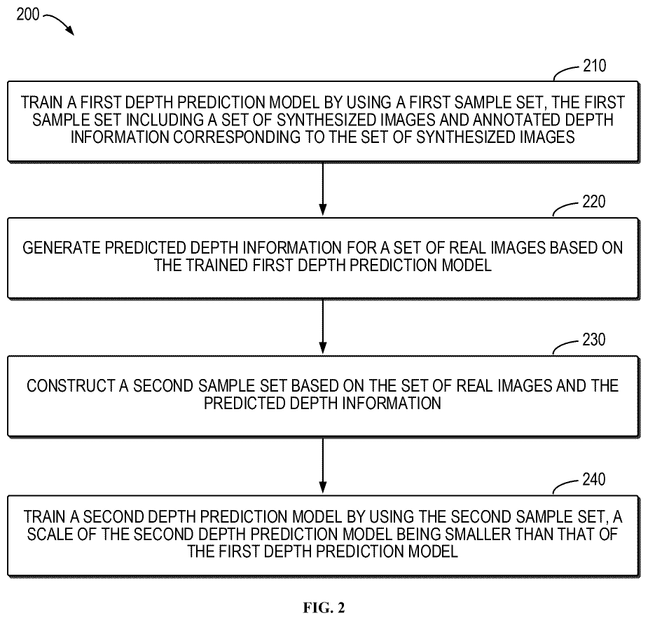

A specific process of training the depth prediction model by the information processing system 100 will be further described below in conjunction with FIG. 2. FIG. 2 shows a flowchart of an example process 200 for information processing according to some embodiments of the present disclosure. The process 200 may, for example, be implemented at the information processing system 100 as shown in FIG. 1. The process 200 will be described below with reference to FIG. 1.

As shown in FIG. 2, at block 210, the information processing system 100 trains a first depth prediction model by using a first sample set, the first sample set including a set of synthesized images and annotated depth information corresponding to the set of synthesized images.

In some embodiments, the first depth prediction model 114 may also be referred to as a depth estimation model, which may, for example, be implemented based on a monocular depth estimation (MDE) model. Such a depth prediction model114 may, for example, output depth information of an image, which may, for example, be represented as a depth map or as a disparity level for each pixel.

In some embodiments, the first depth prediction model 114 may be a pre-trained depth prediction model. For example, such a depth prediction model may include a MDE model that is pre-trained by using real images and the corresponding annotated depth information.

In some embodiments, the first sample set 112 may include only a large number of synthesized images 116. Such synthesized images116 may, for example, be derived from published synthesized image data. Alternatively, such synthesized images 116 may, for example, be synthesized by using an image engine, and the corresponding annotated depth information 118 may be determined based on a generation process of the image engine. Compared with the annotated depth information of the real images, the annotated depth information 118 corresponding to the synthesized images 116 will be more accurate. Furthermore, the number of such synthesized images 116 will also not be restrained.

In some embodiments, during the process of training the first depth prediction model 114, the information processing system 100 may generate intermediate depth information of the set of synthesized images 116 by using the first depth prediction model 114. Further, the information processing system 100 may determine a training loss based on a comparison of the intermediate depth information and the annotated depth information 118.

In some embodiments, for the synthesized image 116, the information processing system 100 may determine a region trend of a plurality of regions in the synthesized image 116 based on a difference between the intermediate depth information and the annotated depth information which correspond to the synthesized image 116.

Further, the information processing system 110 may determine from the plurality of regions a set of target regions with region losses greater than a threshold. Further, the information processing system 100 may determine the training loss based on the region losses of the set of target regions.

Specifically, in the process of determining the training loss, the information processing system 110 may, for example, ignore N regions with the largest region loss in the synthesized image 116, and consider the annotated information corresponding to such regions to be possible noise labels. As an example, N may be a predetermined number or a number predetermined based on a predetermined proportion.

Further, the information processing system 100 may adjust parameters of the first depth prediction model 114 based on the training loss, so as to complete the training of the first prediction model 114.

On the one hand, because the depth information of the synthesized images is more accurate, the embodiments of the present disclosure can ensure high precision of the depth annotation by using the synthesized images for training the teacher model. For example, the synthesized images can provide precise depth information for all details, including transparent objects and reflective surfaces, which helps the model learn how to handle these complex situations.

On the other hand, depth annotations in a real image dataset may have noise, which will negatively affect a training effect of the model. Such noise can be avoided by use of the synthesized images, which improves the generalization ability of the model.

At box 220, the information processing system 100 generates predicted depth information for a set of real images based on the trained first depth prediction model.

Specifically, as shown in FIG. 1, the information processing system 100 may acquire a plurality of unannotated real images 132. Unlike the synthesized images 116, the real images 132 may be images taken in the real world by a camera or other image capturing device.

As shown in FIG. 1, the trained first depth prediction model 114 may generate prediction depth information 134 of the plurality of real images 132.

At box 230, the information processing system 100 constructs a second sample set based on the set of real images and the predicted depth information.

In some embodiments, the information processing system 100 may construct a second sample set 136 by combining the real images 132 and the corresponding predicted depth information 134.

In some embodiments, in order to improve the reliability of the predicted depth information 134, the information processing system 100 may also update the predicted depth information 134 based on semantic analysis of the real images 132.

Specifically, the information processing system 100 may determine a target region associated with a predetermined object type in the real images 132 based on semantic information of the real images 132. In some embodiments, such a predetermined object type may include, for example, a sky object, or other type of object with a defined disparity level.

Further, the information processing system 100 may update the predicted depth information 134 to set a depth associated with the target region to a predetermined value. For example, the information processing system 100 may set a disparity level corresponding to the area correspondingly associated with the sky to zero.

Further, the information processing system 100 may construct a second sample set 136 based on the real images 132 and the updated predicted depth information 134.

At block 240, the information processing system 100 trains a second depth prediction model by using the second sample set, a scale of the second depth prediction model being smaller than that of the first depth prediction model.

Specifically, as shown in FIG. 1, the information processing system 100 may train a second depth prediction model 152 with a smaller scale by using the real images 132 in the second sample set 136 and corresponding depth labels (i.e., predicted depth information 134).

In some embodiments, the information processing system 100 may train a plurality of second depth prediction models 152 corresponding to different scales (e.g., different magnitudes of parameters of the models).

On the one hand, by generating pseudo-depth labels on the real images and training the student model with these labels, the model can be better adapted to the real-world data distribution, thereby improving its generalization ability in unknown scenes.

In addition, the embodiments of the present disclosure are also capable of training models of different scales, from small scale to large-scale, to adapt to different application scenarios and computing resource constraints. By training such a student model, it is possible to obtain more lightweight models that have faster inference speeds while maintaining high accuracy.

In addition, due to possible distribution differences between the synthesized images and the real images, it may be difficult for models trained directly with the synthesized images to adapt to real-world scenarios. This distribution difference can be compensated by generating pseudo-labels (i.e., the predicted depth information of the real images) as discussed above, thereby improving the reliability of the model.

### Example Apparatus and Device

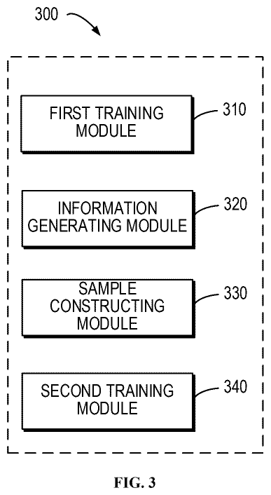

Embodiments of the present disclosure further provide a corresponding apparatus for implementing the method or process above. FIG. 3 shows a schematic structural block diagram of an example information processing apparatus 300 according to some embodiments of the present disclosure. The apparatus 300 may be implemented or included in an electronic device. Various modules/components in the apparatus 300 may be implemented by hardware, software, firmware, or any combination thereof.

As shown in FIG. 3, the apparatus 300 includes: a first training module 310, configured to train a first depth prediction model by using a first sample set, the first sample set including a set of synthesized images and annotated depth information corresponding to the set of synthesized images; an information generation module 320, configured to generate predicted depth information for a set of real images based on the trained first depth prediction model; a sample construction module 330, configured to construct a second sample set based on the set of real images and the predicted depth information; and a second training module 340, configured to train a second depth prediction model by using the second sample set, a scale of the second depth prediction model being smaller than that of the first depth prediction model.

In some embodiments, the sample construction module 330 is further configured to: determine a target region in the set of real images based on semantic information of the set of real images, the target region being associated with a predetermined object type; update the predicted depth information to set a depth associated with the target region to a predetermined value; and construct the second sample set based on the set of real images and the updated predicted depth information.

In some embodiments, the sample construction module 330 is further configured in such a way: the predetermined object type includes a sky object, and the predetermined value indicates that a disparity level of the target region corresponding to the sky object is zero.

In some embodiments, the sample construction module 330 is further configured in such a manner: training the second depth prediction module by using the second sample set includes: training a plurality of second depth prediction models by using the second sample set, the plurality of second depth prediction models corresponding to different scales.

In some embodiments, the information generation module 320 is further configured in such a manner: the set of synthesized images is generated by using an image engine, and the annotated depth information is determined based on a generation process of the image engine.

In some embodiments, the first training module 310 is further configured in such a manner: the training the first depth prediction model by using the first sample set includes: generating intermediate depth information of the set of synthesized images by using the first depth prediction model; determining a training loss based on a comparison of the intermediate depth information and the annotated depth information; and adjusting parameters of the first depth prediction model based on the training loss.

In some embodiments, the first training module 310 is further configured in such a manner: determining the training loss based on the comparison of the intermediate depth information and the annotated depth information includes: for a target synthesized image in the set of synthesized images, determining region losses of a plurality of regions in the target synthesized image based on the intermediate depth information and the annotated depth information; determining from the plurality of regions a set of target regions with region losses greater than a threshold; and determining the training loss based on the region losses of the set of target regions.

In some embodiments, the first training module 310 is further configured in such a manner: the first depth prediction model includes a pre-trained deep prediction model.

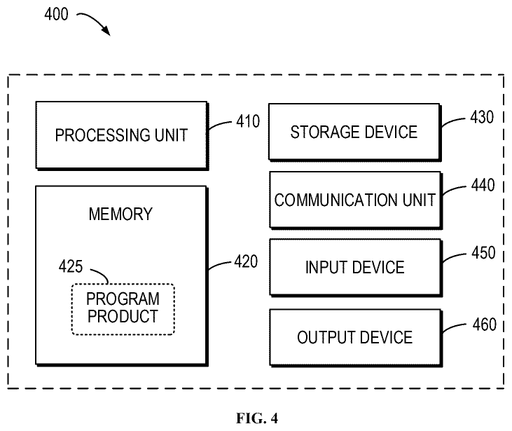

FIG. 4 shows a block diagram of an electronic device 400 capable of implementing one or more embodiments of the present disclosure. It should be understood that the electronic device 400 shown in FIG. 4 is merely exemplary and should not constitute any limitation on the functions and scope of the embodiments described herein. The electronic device 400 shown in FIG. 4 may be used to implement the information processing system 100 shown in FIG. 1.

As shown in FIG. 4, the electronic device 400 is in the form of a general-purpose computing device. Components of the electronic device 400 may include, but are not limited to, one or more processors or processing units 410, a memory 420, a storage apparatus 430, one or more communication units 440, one or more input apparatuses 450, and one or more output apparatuses 460. The processing unit 410 may be an actual or virtual processor and can execute various processing according to programs stored in the memory 420. In a multiprocessor system, multiple processing units execute computer-executable instructions in parallel to improve a parallel processing capability of the electronic device 400.

The electronic device 400 typically includes multiple computer storage mediums. Such mediums may be any available mediums accessible by the electronic device 400, and include but are not limited to volatile and nonvolatile mediums, and removable and non-removable mediums. The memory 420 may be a volatile memory (such as a register, a cache and a random access memory (RAM)), a nonvolatile memory (such as a read-only memory (ROM), an electrically erasable programmable read-only memory (EEPROM) and a flash memory) or some combinations thereof. The storage apparatus 430 may be a removable or non-removable medium and may include a machine-readable medium, such as a flash drive, a magnetic disk or any other mediums, which can be used to store information and/or data (such as training data for training) and may be accessed within the electronic device 400.

The electronic device 400 may further include additional removable/non-removable, volatile/nonvolatile storage mediums. Although not shown in FIG. 4, a disk drive for reading from or writing into a removable and nonvolatile magnetic disk (such as a “floppy disk”) and an optical disk drive for reading from or writing into a removable and nonvolatile optical disk may be provided. In these cases, each drive may be connected to a bus (not shown) by one or more data medium interfaces. The memory 420 may include a computer program product 425 having one or more program modules configured to execute various methods or actions according to various embodiments of the present disclosure.

The communication unit 440 realizes communication with other computing devices through a communication medium. Additionally, functions of the components of the electronic device 400 may be realized in a single computing cluster or a plurality of computing machines, and these computing machines can communicate through communication connections. Therefore, the electronic device 400 can operate in a networked environment by using logical connections with one or more other servers, a network personal computer (PC) or another network node.

The input apparatus 450 may be one or more input devices, such as a mouse, a keyboard and a trackball. The output apparatus 460 may be one or more output devices, such as a display, a speaker and a printer. The electronic device 400 may also communicate with one or more external devices (not shown), such as storage devices and display devices, through the communication unit 440 as needed, communicate with one or more devices that enable users to interact with the electronic device 400, or communicate with any devices (such as network cards and modems) that enable the electronic device 400 to communicate with one or more other computing devices. Such communication may be executed via an input/output (I/O) interface (not shown).

According to an exemplary embodiment of the present disclosure, a computer-readable storage medium is provided and has computer-executable instructions stored thereon, wherein the computer-executable instructions are executed by a processor to implement the method described above. According to an exemplary embodiment of the present disclosure, a computer program product is also provided, is tangibly stored on a non-transitory computer-readable medium, and includes computer-executable instructions, which are executed by a processor to implement the method described above. According to an exemplary embodiment of the present disclosure, a computer program product is provided and has a computer program stored thereon, which, when executed by a processor, implements the method described above.

Various aspects of the present disclosure are described herein with reference to the flowcharts and/or block diagrams of the method, apparatus, device and computer program product implemented according to the present disclosure. It should be understood that each block of the flowcharts and/or block diagrams and combinations of various blocks in the flowcharts and/or block diagrams may be realized by computer-readable program instructions.

These computer-readable program instructions may be provided to the processing unit of a general-purpose computer, a special-purpose computer or other programmable data processing apparatus to produce a machine, so that these instructions, when executed by the processing unit of the computer or other programmable data processing apparatus, produce the apparatus realizing the functions/actions specified in one or more blocks in the flowcharts and/or block diagrams. These computer-readable program instructions may also be stored in a computer-readable storage medium, and these instructions enable the computer, the programmable data processing apparatus and/or other devices to work in a particular manner, so that the computer-readable medium having the instructions stored includes an article of manufacture including the instructions realizing various aspects of the functions/actions specified in one or more blocks in the flowcharts and/or block diagrams.

The computer-readable program instructions may be loaded onto the computer, other programmable data processing apparatuses, or other devices, such that a series of operation steps are executed on the computer, other programmable data processing apparatuses, or other devices to produce a computer-implemented process. Therefore, the instructions executed on the computer, other programmable data processing apparatuses, or other devices realize the functions/actions specified in one or more blocks in the flowcharts and/or block diagrams.

The flowcharts and block diagrams in the figures show possibly realized architectures, functions and operations of systems, methods and computer program products according to multiple embodiments of the present disclosure. In this regard, each block in the flowcharts or block diagrams may represent a module, a program segment or a part of instruction, and the module, the program segment or the part of instruction contains one or more executable instructions for realizing specified logical functions. In some alternative embodiments, the functions noted in the blocks may also occur in a different order than those noted in the figures. For example, two consecutive blocks may be actually executed substantially in parallel, and sometimes they may be executed in a reverse order, depending on the functions involved. It should also be noted that each block in the block diagrams and/or flowcharts and combinations of the blocks in the block diagrams and/or flowcharts may be realized by a dedicated hardware-based system executing specified functions or actions, or may be realized by a combination of dedicated hardware and computer instructions.

Various embodiments of the present disclosure have been described above, and the above descriptions are exemplary, are not exhaustive, and are not limited to the disclosed various embodiments. Many modifications and changes will be obvious to those ordinary skilled in the art without departing from the scope and spirit of the described various embodiments. The terminology used herein is chosen to best explain principles of various embodiments, practical application or improvement to technologies in the market, or to enable other ordinary skilled in the art to understand various embodiments disclosed herein.

What is claimed is:

1. A method for information processing, comprising:
training a first depth prediction model by using a first sample set, the first sample set comprising a set of synthesized images and annotated depth information corresponding to the set of synthesized images;
generating predicted depth information for a set of real images based on the trained first depth prediction model;
constructing a second sample set based on the set of real images and the predicted depth information; and
training a second depth prediction model by using the second sample set, a scale of the second depth prediction model being smaller than that of the first depth prediction model.

2. The method of claim 1, further comprising:
determining a target region in the set of real images based on semantic information of the set of real images, the target region being associated with a predetermined object type;
updating the predicted depth information to set a depth associated with the target region to a predetermined value; and
constructing the second sample set with the set of real images and the updated predicted depth information.

3. The method of claim 2, wherein the predetermined object type comprises a sky object, and the predetermined value indicates that a disparity level of the target region corresponding to the sky object is zero.

4. The method of claim 3, wherein training the second depth prediction model by using the second sample set comprises:
training a plurality of second depth prediction models by using the second sample set, the plurality of second depth prediction models corresponding to different scales.

5. The method of claim 1, wherein the set of synthesized images is generated by using an image engine, and the annotated depth information is determined based on a generation process of the image engine.

6. The method of claim 1, wherein training the first depth prediction model by using the first sample set comprises:
generating intermediate depth information of the set of synthesized images by using the first depth prediction model;
determining a training loss based on a comparison of the intermediate depth information and the annotated depth information; and
adjusting parameters of the first depth prediction model based on the training loss.

7. The method of claim 6, wherein determining the training loss based on the comparison of the intermediate depth information and the annotated depth information comprises:
for a target synthesized image in the set of synthesized images, determining region losses of a plurality of regions in the target synthesized image based on the intermediate depth information and the annotated depth information;
determining, from the plurality of regions, a set of target regions with region losses greater than a threshold; and
determining the training loss based on the region losses of the set of target regions.

8. The method of claim 1, wherein the first depth prediction model comprises a pretrained depth prediction model.

9. An electronic device, comprising:
at least one processor; and
at least one memory, which is coupled to the at least one processor and configured to store instructions executed by the least one processor, the instructions, when executed by the least one processor, causing the electronic device to perform acts comprising:
training a first depth prediction model by using a first sample set, the first sample set comprising a set of synthesized images and annotated depth information corresponding to the set of synthesized images;
generating predicted depth information for a set of real images based on the trained first depth prediction model;
constructing a second sample set based on the set of real images and the predicted depth information; and
training a second depth prediction model by using the second sample set, a scale of the second depth prediction model being smaller than that of the first depth prediction model.

10. The electronic device of claim 9, wherein the acts further comprise:
determining a target region in the set of real images based on semantic information of the set of real images, the target region being associated with a predetermined object type;
updating the predicted depth information to set a depth associated with the target region to a predetermined value; and
constructing the second sample set with the set of real images and the updated predicted depth information.

11. The electronic device of claim 10, wherein the predetermined object type comprises a sky object, and the predetermined value indicates that a disparity level of the target region corresponding to the sky object is zero.

12. The electronic device of claim 11, wherein training the second depth prediction model by using the second sample set comprises:
training a plurality of second depth prediction models by using the second sample set, the plurality of second depth prediction models corresponding to different scales.

13. The electronic device of claim 9, wherein the set of synthesized images is generated by using an image engine, and the annotated depth information is determined based on a generation process of the image engine.

14. The electronic device of claim 9, wherein training the first depth prediction model by using the first sample set comprises:
generating intermediate depth information of the set of synthesized images by using the first depth prediction model;
determining a training loss based on a comparison of the intermediate depth information and the annotated depth information; and
adjusting parameters of the first depth prediction model based on the training loss.

15. The electronic device of claim 14, wherein determining the training loss based on the comparison of the intermediate depth information and the annotated depth information comprises:
for a target synthesized image in the set of synthesized images, determining region losses of a plurality of regions in the target synthesized image based on the intermediate depth information and the annotated depth information;
determining, from the plurality of regions, a set of target regions with region losses greater than a threshold; and
determining the training loss based on the region losses of the set of target regions.

16. The electronic device of claim 9, wherein the first depth prediction model comprises a pretrained depth prediction model.

17. A non-transitory computer-readable storage medium, storing a computer program thereon, the computer program being executable by a processor to implement acts comprising:
training a first depth prediction model by using a first sample set, the first sample set comprising a set of synthesized images and annotated depth information corresponding to the set of synthesized images;
generating predicted depth information for a set of real images based on the trained first depth prediction model;
constructing a second sample set based on the set of real images and the predicted depth information; and
training a second depth prediction model by using the second sample set, a scale of the second depth prediction model being smaller than that of the first depth prediction model.

18. The non-transitory computer-readable storage medium of claim 17, wherein the acts further comprise:
determining a target region in the set of real images based on semantic information of the set of real images, the target region being associated with a predetermined object type;
updating the predicted depth information to set a depth associated with the target region to a predetermined value; and
constructing the second sample set with the set of real images and the updated predicted depth information.

19. The non-transitory computer-readable storage medium of claim 18, wherein the predetermined object type comprises a sky object, and the predetermined value indicates that a disparity level of the target region corresponding to the sky object is zero.

20. The non-transitory computer-readable storage medium of claim 19, wherein training the second depth prediction model by using the second sample set comprises:
training a plurality of second depth prediction models by using the second sample set, the plurality of second depth prediction models corresponding to different scales.
